(19) United States
(12) Patent Application Publication
(10) Pub. No.: US 2026/0292425 A1
(43) Pub. Date: Sep. 24, 2026

(54) MACHINE LEARNING METHODS FOR GENERATING PARAMETRIC STEREO PARAMETERS FROM MONO SIGNALS

(71) Applicants: Dolby Laboratories Licensing Corporation, San Francisco, CA (US); DOLBY INTERNATIONAL AB, Dublin (IE)

(72) Inventors: Joan SERRA, Barcelona (ES); Giulio CENGARLE, Barcelona (ES); Davide SCAINI, Barcelona (ES); Santiago PASCUAL, Barcelona (ES); Daniel ARTEAGA, Barcelona (ES); Jordi PONS PUIG, Olot (ES); Dirk Jeroen BREEBAART, Ultimo (AU)

(73) Assignees: Dolby Laboratories Licensing Corporation, San Francisco, CA (US); DOLBY INTERNATIONAL AB, Dublin (IE)

(21) Appl. No.: 19/471,310

(22) PCT Filed: Mar. 27, 2024
(86) PCT No.: PCT/US2024/021717

§ 371 Date: Sep. 30, 2025

Related U.S. Application Data
(60) Provisional application No. 63/499,282, filed on May 1, 2023.
(60) Provisional application No. 63/623,078, filed on Jan. 19, 2024.

(30) Foreign Application Priority Data
Apr. 3, 2023 (ES) P202330275

(51) Int. Cl. H04S 5/00; G10L 19/008

(52) U.S. Cl. CPC H04S 5/00; G10L 19/008

(57) ABSTRACT

An aspect relates to a method for converting a mono audio signal into a stereo audio signal, the method comprising: generating parametric stereo parameters by inputting the mono audio signal to a machine learning model, wherein the machine learning model is configured to generate parametric stereo parameters given an input mono audio signal; and converting the mono audio signal into the stereo audio signal by performing parametric stereo decoding of the mono audio signal using the parametric stereo parameters.

### CROSS-REFERENCE TO RELATED APPLICATIONS

This application claims the priority benefit of Spanish Application No. P202330275 filed Apr. 3, 2023, U.S. Provisional Patent Application No. 63/499,282 filed May 1, 2023, and U.S. Provisional Patent Application No. 63/623,078 filed Jan. 19, 2024, each of which is incorporated by reference in their entireties.

### TECHNICAL FIELD

The present disclosure relates to methods and systems for converting a mono audio signal into a stereo audio signal.

### BACKGROUND

Single-channel monophonic (mono) signals are found in multiple situations, such as historical recordings or current ones made with a single microphone (e.g., field recordings, amateur band rehearsals, etc.). Even recordings made with two or more microphones that are not spaced enough or that do not have enough directivity may be better treated by downmixing to mono (e.g., mobile phone recordings). Furthermore, many processing algorithms, including modern deep neural network algorithms, cannot yet or are simply not designed to handle more than one channel. Unlike these scenarios, the most common listening experiences, either through loudspeakers or headphones, involve two channel stereophonic (stereo) signals. Hence, the usefulness of the conversion from mono to stereo.

Classical approaches to produce a pseudo-stereo effect from a mono signal are based on decorrelation. Initial approaches used time delays and complementary filters, although all-pass filters are more commonly used nowadays, together with multi-band processing to improve the effect. Instead of multi-band, estimation of foreground/background time-frequency tiles can also be performed. Decorrelation approaches, however, only provide a mild stereo effect, with limited width, and cannot spatially separate individual elements in the mix.

To overcome the latter, source separation approaches have been considered. The main idea is that, if individual elements or tracks are available, those can be panned to any location, producing a more realistic spatial image. Nevertheless, this approach presents several drawbacks: firstly, even the best performing source separation algorithms produce artifacts, which will be highly audible in the stereo render; secondly, current separation algorithms are very restrictive in the number and types of elements they can separate, thus considerably limiting their application in spatialization approaches; thirdly, after elements or tracks are separated, it remains to be seen how they can be automatically panned in a realistic manner, which is the reason why separation-based approaches usually involve user intervention in the panning stage.

Accordingly, there is a need for improved approaches for converting mono signals to stereo signals, not relying on decorrelation or source separation.

### SUMMARY

Systems and methods are disclosed for converting monophonic signals to stereophonic ones (mono to stereo) without using any additional sources of information. To do so, parametric stereo (PS) encodings and machine learning models are leveraged.

According to a first aspect there is provided a method for converting a mono audio signal into a stereo audio signal, the method comprising:
generating parametric stereo parameters by inputting the mono audio signal to a machine learning model, wherein the machine learning model is configured to generate parametric stereo parameters given an input mono audio signal; and
converting the mono audio signal into the stereo audio signal by performing parametric stereo decoding of the mono audio signal using the generated parametric stereo parameters.

The method is based on the realization that mono-to-stereo conversion is a field suitable for machine learning and generative-based approaches, and accordingly that parametric stereo parameters may be generated or predicted for an input mono audio signal. The input mono audio signal may subsequently be converted to a stereo audio signal by performing parametric stereo decoding using the parametric stereo parameters. The conversion of the mono audio signal into the stereo audio signal does not rely on side information. The method may thus be applied to mono audio signals which have not been previously subjected to parametric stereo encoding to generate the mono audio signal and associated parametric stereo parameters.

The parametric stereo parameters may comprise one or more parameters indicating inter-channel properties. The parametric stereo parameters may comprise at least one of an inter-channel intensity difference, an inter-channel coherence value, an inter-channel coherence value, an inter-channel level difference, an inter-channel prediction coefficient, an inter-channel phase difference, and/or an inter-channel time difference. In some embodiments, the parametric stereo parameters comprise inter-channel intensity differences, IID, and inter-channel coherence, IC, and optionally inter-channel time differences.

In some embodiments, generating the parametric stereo parameters comprises: obtaining a spectral representation of the mono audio signal; and generating parametric stereo parameters for the spectral representation of the mono audio signal. That is, the parametric stereo parameters may be generated by inputting the spectral representation of the mono audio signal into the machine learning model. The machine learning model may correspondingly be configured to generate parametric stereo parameters given a spectral representation of an input mono audio signal. A spectral representation, for instance in the form of a spectrogram, facilitates capturing spectral information which may be useful for generating the parametric stereo parameters. The spectral representation may be obtained by transforming the mono audio signal into the spectral representation using a short-time Fourier transform. The parametric stereo parameters may for instance be generated on a frame-by-frame basis of the spectral representation.

In some embodiments, generating the parametric stereo parameters comprises, for each frame of the spectral representation of the mono audio signal:
generating a key vector based on the frame;
querying, using the generated key vector, a data structure storing key-value vector pairs, to determine k≥1 sets of parametric stereo parameters, wherein the value vector of each key-value pair comprises a set of parametric stereo parameters, and wherein the k sets of parametric parameters are the k sets of parametric stereo parameters of the data structure associated with the k key vectors nearest the generated key vector; and
determining a set of parametric stereo parameters for the frame based on the k sets of parametric stereo parameters.

Parametric stereo parameters may thus be generated using a machine learning model implementing a nearest neighbor-based approach. This enables determining parametric stereo parameters in a computationally efficient manner, by querying a data structure storing predetermined sets of parametric stereo parameters. The nearest neighbor-based approach enables real-time or even faster than real-time mono-to-stereo conversion. By querying the data structure using a respective key vector generated for each frame, the parametric stereo parameters may be generated on a frame-by-frame basis and thus reflect temporal variations in the spectral representation (e.g., spectrogram) of the mono audio signal.

In some embodiments, generating the respective key vector for each frame comprises computing band energies for the frame. Parametric stereo encodings are typically based on band energies. A key vector based on band energies may hence be a relevant metric for querying the data structure.

In some embodiments, generating the respective key vector for each frame further comprises computing band energies for a number of neighboring frames to the respective frame, and averaging the band energies over the respective frame and the neighboring frames. The key vector may hence be computed taking into account a number of neighboring frames. Rapid changes in band energies, which otherwise could lead to correspondingly rapid changes in the generated parametric stereo parameters, may hence be smoothed. Correspondingly, the key vector of each key-value pair of the data structure may comprise an average band energy.

In some embodiments, the data structure is queried to determine k>1 sets of parametric stereo parameters, wherein determining the set of parametric stereo parameters for the frame comprises randomly selecting one of the k sets of parametric stereo parameters. Determining more than one nearest neighbor to the key vector for each frame, may confer a generative character to the machine learning mode in the sense that there may be a random variation to the parametric stereo parameters.

In some embodiments, the sets of parametric stereo parameters determined for the frames forms a sequence of sets of parametric stereo parameters, wherein the method further comprises performing post-processing of the sequence of sets of parametric stereo parameters, the post-processing comprising: performing a sign change of at least one parameter of the set of parametric stereo parameters for a frame on a condition that the sign change results in a smaller distance to a corresponding parameter of the set of parametric stereo parameters for a previous frame; and/or smoothing of the sequence of sets of parametric stereo parameters. Thereby, effects including rapid panning from one channel to the other and unrealistic source movements in stereo audio signal may be mitigated.

In some embodiments, the method further comprises: obtaining an audio content type indicator; and selecting the data structure from a set of data structures, wherein each data structure is associated with a respective audio content type indicator, and wherein the data structure is selected in accordance with the obtained audio content type indicator. Respective data structures suited for different types of audio content may hence be provided and queried, thus allowing a content type-dependent generation of the parametric stereo parameters.

In some embodiments, the machine learning model is configured as a deep neural network comprising a generative model trained to generate, based on the spectral representation, the parametric stereo parameters. The parametric stereo parameters may thus be generated using a machine learning model configured as a deep neural network (DNN). A realization underlying the present disclosure is that generative models based on DNNs may be especially suitable for generating parametric stereo parameters, in view of the often subjective choices made during mixing stages of an audio production, such as music recordings where artists and engineers may exploit the stereo image to serve a creative artistic intent.

In some embodiments, generating the parametric stereo parameters comprises generating, for each frame of the spectral representation of the mono audio signal, a set of parametric stereo parameters using the deep neural network.

In some embodiments, the generative model comprises at least one of a generative adversarial network, a diffusion model, an autoregressive model, and/or a masked token generative model. These are all types of generative models suitable for generating parametric stereo parameters.

In particular, the iterative sampling used in a masked token generative model may enable orders of magnitude faster implementations compared to for instance autoregressive modeling. More specifically, the masked token generative model may be trained to generate patch representations comprising parametric stereo parameters for a number of frames, wherein the parametric stereo parameters define tokens of the patch representations and a patch representation is generated by iteratively: sampling a masked patch, predicting tokens of the masked patch, selecting a number of the predicted tokens with a highest logit score, and unmasking the selected number of predictions for the next iteration. The tokens may be predicted using classifier-free guidance.

In some embodiments, the generative model comprises a transformer architecture.

In some embodiments, the generative model is trained to minimize a categorical cross-entropy loss.

In some embodiments, the generative model is further configured to receive conditioning information comprising an audio content type indicator and/or a target stereo image, and to generate the parametric stereo parameters given the input mono audio signal and the conditioning information, and wherein generating the parametric stereo parameters comprises inputting, to the generative model, the mono audio signal and conditioning information comprising an audio content type indicator and/or a target stereo image. Use of such conditioning information provides a degree of control over the generated parametric stereo parameters and thus stereo image of the stereo audio signal.

According to a second aspect there is provided a system for converting a mono audio signal into a stereo audio signal, the system comprising: a machine learning model configured to generate parametric stereo parameters given an input mono audio signal; and a parametric stereo decoder configured to convert the input mono audio signal into the stereo audio signal using the parametric stereo parameters generated by the machine learning model.

According to a third aspect there is provided a computer program product comprising computer program code portions configured to perform the method according to the first aspect when executed on a computer processor.

According to a fourth aspect there is provided a computer-readable storage medium storing the computer program product according to the second aspect.

The second, third and fourth aspects may feature the same effects and advantages as discussed with reference to the method of the first aspect. Any functions described in relation to a method, may have corresponding features in a system, device or a computer program product.

### BRIEF DESCRIPTION OF THE DRAWINGS

The aspects of the present disclosure will be described in more detail with reference to the appended drawings, showing example implementations.

FIG. 1 is a schematic block diagram of a PS encoder and a PS decoder.

FIG. 2 is a schematic block diagram of a system for converting a mono audio signal into a stereo audio signal, according to an example implementation.

FIG. 3 is a flow chart of a method for generating PS parameters for an input mono audio signal, according to an example implementation.

FIG. 4 shows preference results for subjective tests.

FIG. 5 illustrates a schematic block diagram of an example device or architecture that may be used to implement embodiments of the invention.

### DETAILED DESCRIPTION

As discussed above, classical correlation-based approaches, may provide only a mild stereo effect, with limited width, and cannot spatially separate individual elements in the mix. Meanwhile, approaches based on source separation involves a panning stage which typically involves user-intervention.

Music is a paradigmatic example where, apart from the stereo recording itself, artists and engineers exploit the stereo image to serve a creative artistic intent. Instrument panning is a fundamental part of music mixing, and achieving the right balance requires musical sensibility as well as technical knowledge. However, apart from some style conventions, the stereo image of a music mix in a highly subjective construct: given a set of input tracks, there are many plausible stereo renditions from which selecting the final mix is practically only a matter of artistic choice.

As realized by the inventors, mono-to-stereo conversion is hence a field suitable for modern deep generative models. The present disclosure provides approaches using machine learning techniques and parametric stereo (PS) decoding for converting mono to stereo.

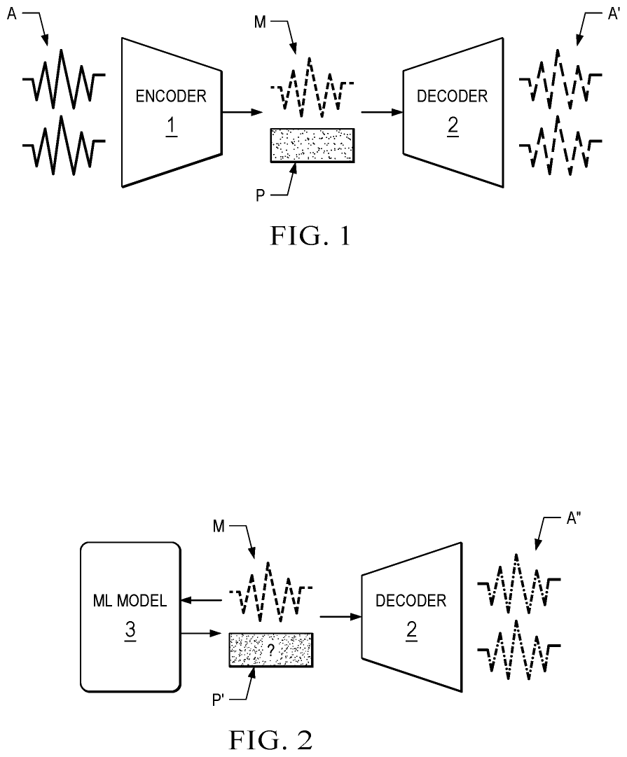

PS is a coding technique that allows to transmit a stereo signal through a mono signal plus side information that, with enough bit rate, can recover an almost transparent version of the original stereo. FIG. 1 is a schematic depiction of a PS encoder 1 and a PS decoder 2 according to an example. The PS encoder 1 receives as input a stereo audio signal A (herein for brevity also referred to as “stereo signal”) and outputs a mono audio signal M (herein for brevity also referred to as “mono signal”) and side information in the form of PS parameters P. As indicated in FIG. 1, the PS parameters P allow the PS decoder 2 to convert the input mono audio signal M into a reconstructed stereo audio signal A′ by performing parametric stereo decoding of the mono audio signal M using the PS parameters P.

The present disclosure provides approaches leveraging machine learning algorithms to generate or predict plausible versions of PS parameters in situations where side information is not available. These PS parameters can then be used to decode an existing mono signal into a plausible stereo one.

FIG. 2 is a schematic block diagram of a system according to the present disclosure, comprising a machine learning model 3 configured or trained to generate PS parameters P′ given an input mono audio signal M. Given the mono audio signal M and the PS parameters P′ generated by the machine learning model 3 as input, the PS decoder 2 may accordingly convert the mono audio signal M into a stereo audio signal A″ by performing parametric stereo decoding of the mono audio signal M using the PS parameters P′ generated or predicted by the machine learning model 3. The PS parameters may be generated through a machine learning model trained on a corpus of stereo signals and their PS encodings (that is, their mono downmix and PS parameters) such that the machine learning model later may produce the PS parameters P′ from the mono audio signal M alone.

More specifically, the training corpus of stereo signals may be encoded through a parametric stereo coding algorithm. For example, in some implementations each stereo signal of the training corpus may be encoded using the parametric coding algorithm described in Breebaart et al. Parametric coding of stereo audio. EURASIP Journal on Advances in Signal Processing, 561917, 2005, hereby incorporated by reference in its entirety. However, any parametric stereo algorithm may be utilized to encode the training corpus of stereo signals and is within the scope of the present disclosure.

The result of the encoding produces a parallel corpus of mono downmix signals and parameter set, which can be used to reconstruct the original stereo signals up to small perceptual differences. With the parallel corpus of mono downmix signals and parameter set, machine learning algorithms may be trained that, given a mono signal (e.g. corresponding to M in FIG. 2), can produce a parameter set (e.g. corresponding to P′ in FIG. 2) being a realistic version of the PS parameters that would be produced by a PS encoder (e.g. the PS encoder 1 of FIG. 1). With the machine learning model 3 thusly trained, the PS decoder 2 (i.e., the decoding counterpart of the PS encoder 1 in FIG. 1) may accordingly, given M and P″, generate (or “reconstruct”), a stereo signal A″ which is a stereo rendering that is ideally as plausible as A′ to the end user.

The present disclosure provides variants based on two different types of generative algorithms to produce PS parameters from a mono audio signal. The first generative model (termed “first approach” in the below) is based on nearest neighbor decoding (NN), and the second one is based on generative modeling with deep neural networks (DNN). For the latter, both common autoregressive modeling and more recent masked token modeling (termed “second approach” and “third approach”, respectively, in the below) are provided.

Some implementations of the generative algorithms may use spectral representations (e.g., spectrograms) obtained from a mono audio signal and PS parameters (i.e., a PS parameter set) as input. With reference to FIG. 2, a spectral representation of a mono audio signal M may be obtained by the machine-learning model 3. The spectral representation may be obtained in the form of a spectrogram. The spectral representation may be obtained by transforming the mono audio signal into a spectral representation using a short-time Fourier transform. The machine learning model 3 may generate PS parameters P′ for the spectral representation of the mono audio signal M. The PS parameters may be obtained on a frame-by-frame basis (that is, every frame has a spectral representation and PS parameters). The PS parameters may comprise multiple types of parameters, and combinations thereof, for example, but not limited to inter-channel level differences, inter-channel phase differences, inter-channel time differences, inter-channel correlation values, inter-channel coherence values, inter-channel prediction coefficients. For example, the generated PS parameters may comprise inter-channel intensity differences (IID), and inter-channel coherence (IC), and optionally also inter-channel time differences. It is here noted that “inter-channel” is considered synonymous to “inter-aural”. Hence, “inter-channel” may for each of the preceding parameter types be replaced by “inter-aural”. Typically, but not necessarily, the PS parameters may be represented as a function of time and/or frequency. The PS decoder 2 may convert the spectral representation of the mono audio signal into a stereo audio signal A″ (e.g., also in the form of a spectral representation, such as a spectrogram) using the generated PS parameters. The PS decoder 2 may more specifically generate a respective spectral representation (e.g., spectrogram) of a left channel signal and a right channel signal, and subsequently converted the spectral representations to waveform domain (i.e., time-domain signals).

### Parametric Stereo

PS exploits the perceptual cues that are more relevant to our spatial perception of sound, namely the fact that directional sources produce interaural level and phase (or time delay) differences, and the fact that diffuse sound fields manifest as decorrelated signals at the two ears. These cues effectively describe how a mono signal is mapped to the left and right stereo channels and can be measured using three quantities or parameters: interchannel intensity differences (IID), interchannel time differences (equivalently, phase differences), and interchannel coherence or correlation (IC). PS parameters may be computed in frequency bands, to reflect the frequency-dependent nature of the spatial properties of stereo content. They may also be computed on a frame-by-frame basis, to reflect the time-varying nature of frequency cues and the spatial image. Once a stereo signal is encoded into its mono downmix and PS parameters, a reasonably accurate stereo presentation can be recovered by applying the time- and frequency-dependent PS parameters to the mono signal. In this step, decorrelation is typically introduced to achieve an interchannel coherence smaller than one.

In the following, for conciseness and ease of understanding, the approaches of the present disclosure will be described with reference to PS parameters comprising IID and IC, which corresponds to the two-parameter stereo coding of Breebaart et al. referenced above, which models IID and IC. However, the approaches are also compatible with any one of the above-mentioned types of parameters, e.g., at least one of an inter-aural intensity difference, an inter-aural coherence value, an inter-channel coherence value, an inter-channel level difference, an inter-channel prediction coefficient, an inter-channel phase difference, and/or an inter-channel time difference. The PS coding strategy will now be discussed, and the main notation will be introduced.

### Encoding

Given two complex spectrograms expressed as complex matrices X and Y, where rows represent frequency bins and columns represent frames, the band-based cross-spectrogram function is defined by

$$ρ ( X , Y ) = B ( X ⊙ {Y}^{*} )$$

where ⊙ denotes elementwise multiplication, * denotes elementwise complex conjugate, and B is a matrix with ones and zeros that is used to sum frequency bins according to a certain frequency band grouping. An example embodiment of the present disclosure may use the spectrogram settings and banding (which are the same as in Breebaart et. al. referenced above): frames of 4,096 samples for 44.1 kHz signals, 75% overlap, a Hann window, and 34 bands which are approximately distributed following equivalent rectangular bandwidths.

Given the two complex spectrograms L and R corresponding to the left and right channels of a stereo signal, the IID parameters may be computed using

$${P}^{I I D} = 10 {log}_{10} ( ρ ( L , L ) \text{?} ρ ( R , R ) )$$

where Ø denotes elementwise division. The IC parameters are similarly derived from the cross-spectrogram following

$${P}^{I C} = Re \{ ρ ( L , R ) \} \text{?} \sqrt{ρ ( L , L ) ⊙ ρ ( R , R )}$$

where Re{ } extracts the real part of each complex value and the square root is applied elementwise. Notice that the use of the real part instead of the absolute value allows to retain information on the relative phase of the two signals that would otherwise be lost. Finally, P^{IID} and P^{IC} may be quantized by individually discretizing each matrix element. To do so, the same quantization steps as in Breebaart et. al. may be used: 31 steps for IID and 8 for IC. The quantized versions of P^{IID} and P^{IC} may be denoted as Q^{IID} and Q^{IC}, respectively. To facilitate subsequent operation, and to prevent mismatches between IID and IC parameters, both parameters may be joined and treated as one parameter. P^{IID} and P^{IC} may be concatenated in the frequency axis to form a single matrix

$$P . {Q}_{i , j}^{IID} and {Q}_{i , j}^{I C}$$

may be fused elementwise into individual integers using

$${Q}_{i , j} = 8 {Q}_{i , j}^{IID} + {Q}_{i , j}^{IC} ( note that {Q}_{i , j}^{IID} and {Q}_{i , j}^{I C}$$

can be recovered using the division and modulo operators).

### Decoding

To decode the above PS encoding, a mixing between the available mono signal and a decorrelated version of it may be performed. A mono signal S may be decorrelated by applying an all-pass filter based on a cascade of four infinite impulse response filters to obtain S^{D} (this all-pass filter is an enhanced version of the basic one proposed in Breebaart et. al. referenced above) With that, the estimated left and right channels \hat{L} and \hat{R} can be decoded by mixing S and S^{D}. The mixing may be performed by

$$\hat{L} = {M}^{A} ⊙ S + {M}^{B} ⊙ {S}^{D}$$

$$\hat{R} = {M}^{C} ⊙ S + {M}^{D} ⊙ {S}^{D}$$

using mixing matrices

$${M}^{A} = {B}^{′} ( {C}^{A} ⊙ cos ( {D}^{B} + {D}^{A} ) )$$

$${M}^{B} = {B}^{′} ( {C}^{A} ⊙ sin ( {D}^{B} + {D}^{A} ) )$$

$${M}^{C} = {B}^{′} ( {C}^{B} ⊙ cos ( {D}^{B} - {D}^{A} ) )$$

$${M}^{D} = {B}^{′} ( {C}^{B} ⊙ sin ( {D}^{B} - {D}^{A} ) )$$

where ′ denotes matrix transposition and matrices C and D are obtained from the coded IC and IID information P^{IC} and P^{IID}. In matrix notation (adapted from the formulation in Breebaart et. al.):

$${C}^{A} = \sqrt{( 2 ( F ⊙ F ) ) \text{?} ( 1 + F ⊙ F )}$$

$${C}^{B} = \sqrt{2 \text{?} ( 1 + F ⊙ F )}$$

$$F = 1 {0}^{{P}^{I I D} / 20}$$

$${D}^{A} = arccos ( {P}^{I C} ) / 2$$

$${D}^{B} = {D}^{A} ⊙ ( {C}^{B} - {C}^{A} ) / \sqrt{2}$$

where trigonometric functions, square roots, and powers are taken elementwise. For further detail and explanation see Breebaart et. al. referenced above.

### Parametric Stereo Generation

Example methods for PS generation will now be described, which all may share the above encoding-decoding formulation. Either the quantized or unquantized versions may be used. During training, stereo signals are used to compute input downmixes S=(L+R)/2 and target PS parameters P or Q. Note that, in the case of the DNN-based generative models considered herein, one may additionally input contextual PS parameters in a teacher-forcing schema (in an example embodiment, input/output audio chunks of 6 s may be used to compute contextual PS parameters). A detailed discussion of teacher-forcing schema is found in “A learning algorithm for continually running fully recurrent neural networks,” (Neural Computation, vol. 1, no. 2, p. 270-280, 1989) by R. J. Williams and D. Zipser.

### Nearest Neighbors

The nearest neighbors approach (the first approach, which may be denoted PS-NN) may in general involve imposing the PS parameters of existing, similar stereo fragments to individual mono frames using a nearest neighbor (NN) algorithm. A detailed discussion of NN algorithms is found in “The elements of statistical learning: data mining, inference, and prediction” (2nd ed. New York, USA: Springer, 2009) by T. Hastie and R. Tibshirani. More specifically, frame-based PS parameters may be retrieved using mono frame sequences, and the sequence of those retrieved parameters may be used to decode the mono input. At training time, the approach may proceed by randomly selecting an audio signal (e.g., a song) from a training corpus, and randomly extracting an N frame spectrogram S (e.g., N=20) and its corresponding parameters P, and computing a key-value vector pair. The spectrogram may be a magnitude spectrogram. The spectrogram may be obtained by a short-time Fourier transform (STFT). The phase may be discarded. The bands may be grouped following the PS encoder setting (e.g., as set out in the Encoding section above). The key vector may be formed by framewise averaging the energy in each band,

$$k = \frac{1}{N} {\sum }_{j = 1}^{N} {BS}_{: , j} \qquad ( 1 )$$

and the value vector may correspond to the PS parameters of the last frame, v=P_{:,N}. This allows for a fully-causal schema. The process may be repeated a large number of times without replacement (e.g., a million times) and all pairs may be stored in a data base or NN structure. At test time, for every frame of the input mono signal, the approach may proceed by computing an average as in Eq. 1, querying the NN structure, retrieving the v vector of the closest neighbor, and assigning it as the predicted PS parameter for that frame. This way, a sequence of estimated PS parameters \hat{P} may be obtained. More generally, the data base may be queried for each frame independently to obtain k≥1 nearest neighbors (that is, the k closest key vectors in the data base and their corresponding PS parameters). One of the k nearest neighbors may then be randomly sampled and assigned as P for the frame. The PS parameters need typically not be averaged but may be concatenated, for every frame and/or frequency band, to form a vector or matrix of values constituting parameter set P for the input mono signal.

In preliminary analysis, it has been observed that the above NN strategy may produce a high-rate ‘wobbling’ effect between left and right (that is, panning was rapidly switching from one channel to the other) and present some temporal in consistencies (that is, sources were unrealistically moving with time, even within one- or two-second windows). To counteract these effects, a two-step post processing may be implemented based on (i) switching the sign of a PS parameter for a frame j

$$( e . g . , {\hat{P}}_{: , j}^{IID} )$$

if the Euclidean distance to the corresponding PS parameter for the preceding frame j−1

$$( e . g . {\hat{P}}_{: , j - 1}^{IID} )$$

was smaller, and (ii) applying an exponential smoothing (also known as exponential moving average) on the columns of \hat{P} with a factor of 0.95. This post-processing substantially reduced the aforementioned undesirable effects.

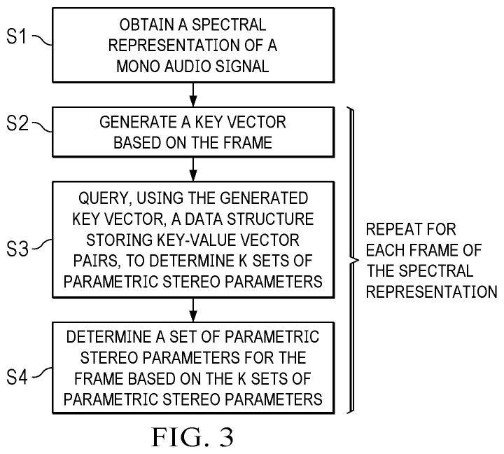

FIG. 3 is a flow chart of an example implementation of a method for generating PS parameters for an input mono audio signal according to the NN-based approach.

At step S1, a spectral representation of a mono audio signal is obtained. The mono audio signal may be a spectrogram. The mono audio signal may be transformed into the spectral representation by applying a STFT to the mono audio signal. The method then proceeds by repeating each of S2-S4 for each frame of the spectral representation of the mono audio signal.

At S2, a key vector is generated based on the frame. Generating the key vector for the frame may comprise computing band energies for the frame. Band energies may be further computed for a number of neighboring frames to the frame. The key vector may be computed using Eq. 1. Accordingly, the computed band energies may be averaged (time-wise) over the set of frames formed by the frame and the neighboring frames. The key vector may thus comprise an average band energy.

At S3, the generated key vector for the frame is used to query a data structure storing key-value vector pairs, to determine k≥1 sets of PS parameters. The value vector of each key-value pair comprises a set of PS parameters. The key-value pairs may be determined as discussed in connection with Eq. 1 above. The k sets of PS parameters are the k sets of parametric parameters of the data structure associated with the k key vectors nearest the generated key vector for the respective frame.

At S4, a set of PS parameters is determined for the respective frame, based on the k sets of PS parameters determined at step S3. In implementations where k=1, the value vector with the key vector nearest the key vector determined for the respective frame may be determined as the set of PS parameters for the respective frame. In implementations where k>1, the set of PS parameters for the respective frame may be based on the k sets of parametric stereo parameters, for instance by randomly selecting one of the k sets of parametric stereo parameters as the set of PS parameters for the respective frame. As may be appreciated, k=1 enables a deterministic generation of PS parameters. On the other hand, k>1 may provide a degree of randomness or diversity in the generation of PS parameters, although the data structure storing the key-value vector pairs is static. In either case, the sets of PS parameters determined for the frames of the spectral representation forms a sequence of sets of PS parameters, each set of PS parameter corresponding to a respective one of the frames of the spectral representation. Optionally, the sequence of sets of PS parameters may be subjected to post-processing to obtain a post-processed and final sequence of sets of PS parameters. The post-processing may comprise performing a sign change of at least one parameter

$$( e . g . {\hat{P}}_{: , j}^{IID} )$$

of the set of PS parameters for each frame j on a condition that the sign change results in a smaller distance to a corresponding parameter

$$( e . g . {\hat{P}}_{: , j}^{IID} )$$

of the set of PS parameters for a previous frame j-1. Additionally or alternatively, smoothing of the sequence of sets of PS parameters may be performed, e.g., exponential smoothing or any other type of processing that limits the rate of change, in order to soften transitions between frames.

In an extension of the NN-based approach, the machine learning model may comprise a set of data structures, wherein each data structure is associated with a respective audio content type indicator. For instance, each data structure may comprise key-value vector pairs determined from a training corpus of audio signals of a respective audio content type. For instance, a respective data structure may be provided for each of a number of different music genres (rock, pop, classical, jazz, electronic, etc.), and/or different audio scenes (concerts, interviews, presentations, outdoor environments, etc.) PS parameters may thus be generated for an input mono signal by further inputting to the machine learning model an audio content type indicator corresponding to the type of audio content the PS parameters should be determined for (e.g., any of the genres or audio scenes exemplified above). The machine learning model may accordingly select the data structure from the set of data structures, in accordance with the obtained audio content type indicator. The generation of the PS parameters may then proceed as set out above, using the selected data structure.

### Deep Neural Network (DNN)

As previously discussed, PS parameters may also be generated using a DNN based approach. Accordingly, in some implementations the PS parameters may be generated using a machine learning model configured as a DNN. The DNN may comprise a generative model trained to generate the PS parameters based on a spectral representation of an input mono audio signal. Generating the PS parameters may comprise generating a set of PS parameters using the generative model for each frame of the spectral representation. Analogous to the NN-based approach, the spectral representation may be a spectrogram, e.g., generated by applying a STFT to the mono audio signal. The spectrogram may especially be a magnitude spectrogram, e.g., obtained by discarding the phase from the STFT of the mono audio signal. The generative model may be trained to generate PS parameters either as continuous

$$( e . g . , {P}^{IID} and {P}^{IC} )$$

or quantized versions

$$( e . g . , {Q}^{IID} and {Q}^{IC} ) .$$

For the latter, the quantized PS parameters may be expressed for every frame and every frequency band into a single token using multiplication and sum. Examples of generative models that may be used include but are not limited to generative adversarial networks (e.g., suitable for generating continuous PS parameters), diffusion models (e.g., suitable for generating continuous PS parameters), autoregressive models (e.g., suitable for generating quantized PS parameters), or masked token generative models (e.g. suitable for generating quantized PS parameters). In turn, generative models can be conformed of various architectures, including but not limited to multilayer perceptrons, convolutional networks, recurrent networks, or Transformer networks. In addition, generative models may exploit past, concurrent, or future parameters P together with their corresponding mono signals S as input, predicting the next or masked parameters P. At generation time, every generative model will follow its own sampling procedure to produce PS parameters. For instance, in case the generative model is trained to generate quantized PS parameters being element-wise fused into individual integers, the PS parameters may be converted to non-fused sampled values of the PS parameters. For example, the element-wise fused quantized PS parameters

$${Q}_{i , j} = 8 {Q}_{i , j}^{IID} + {Q}_{i , j}^{IC}$$

may be converted into the non-fused counterparts

$${Q}_{i , j}^{IID} and {Q}_{i , j}^{IC}$$

using modulo, multiplication or other arithmetic operations.

In implementations wherein the generative model is an autoregressive model or a masked token generative model, the generative model may be Transformer architectures. That is, the generative model may comprise a number of transformer encoder blocks. Each transformer encoder block may comprise multiple channels and multiple heads. The input to the generative model may be formed by projecting the spectral representation of the mono audio signal (e.g., the spectrogram thereof) and teacher-forcing information into an n-channel activation, wherein n is the number of channels of the transformer encoder blocks (see Eq. 2 below for an example of an-channel activation H). The generative model may be trained to minimize a categorical cross-entropy loss (see Eq. 3 below for an example of a weighted categorical cross-entropy loss).

### DNN/Deep Generative Approach—Autoregressive

According to the second approach, PS parameters are modeled with a deep generative approach based on an autoregressive (AR) transformer (see e.g., A. Radford, K. Narashiman, T. Salimans, and I. Sutskever, “Improving language understanding by generative pre-training,” Technical Report, OpenAI, 2018). An example architecture for an AR model (which may be denoted PS-AR) will be disclosed in the following. The architecture is composed by 7 transformer encoder blocks with 512 channels, 16 heads, and a multilayer perceptron (MLP) expansion factor of 3. Sinusoidal positional encoding at the input is used, and a two-layer MLP with an expansion factor of 2 is added at the output to project to the final number of classes (which is 31×8 tokens times 34 bands per frame, see the Encoding section above). The input is formed by a projection of the mono spectrogram S and the teacher-forcing information Q into a 512-channel activation H,

$$H = ϕ ( S ) + {\sum }_{i = 1}^{B} {ξ}_{i} ( {Q}_{i , :} ) \qquad ( 2 )$$

where φ is a two-layer MLP with an expansion factor of 2, B=34 is the number of bands, and ξᵢ is a learnable per-band token embedding of dimension 512. The model is trained with weighted categorical cross-entropy, using the weight

$$w = 1 + λ σ ( max ( - ϵ , min ( ϵ , {P}^{IID} ) ) ) + σ ( {P}^{IC} ) \qquad ( 3 )$$

For every element in the batch, where σ(X) corresponds to the elementwise standard deviation of X, the λ parameter (e.g., λ=0.15) compensates for different magnitudes, and the e parameter (e.g., ϵ=20) is a threshold to take into account the little perceptual relevance of IIDs larger than 20 dB. In preliminary analysis, it may be observed that using w qualitatively improved the results, as it promotes more focus to wider stereo images and more difficult cases.

The AR model may follow a recursive approach, like PixelSNAIL (X. I. Chen, N. Mishra, M. Rohaninejad, and P. Abbeel, “PixelSNAIL: an improved autoregressive generative model,” in Proc. of the Int. Conf. on Machine learning (ICML), 2018, p. 864-872), starting with lower frequency bands, then higher frequency bands, and moving into the next frame once all bands are known/predicted. To efficiently exploit the past context, all input sequences may have full sequence teacher-forcing except for the upper frequency bands of the last frame, which may be masked consecutively and uniformly at random during training.

At test time, recursive sampling may be used following the same masking strategy. A temperature hyperparameter of for instance τ=0.9 may be used. In addition, classifier-free guidance (see e.g. J. Ho and T. Salimans, “Classifier-free diffusion guidance,” in Proc. of the NeurIPS Workshop on Deep Generative Models and Downstream Applications, 2021) may be employed with a hyperparameter γ=0.25 following the formulation in “Muse: text-to-image generation via masked generative transformers,” (ArXiv: 2301.00704, 2023) by H. Chang et. al. This modifies the conditional logits U_{cond} with unconditional ones U_{uncond} such that

$$U = ( 1 + γ ) {U}_{cond} - γ {U}_{uncond} \qquad ( 4 )$$

To have both a conditional and an unconditional model with the same architecture, following common practice, φ(S) in Eq. 2 may be randomly replaced by a learnable dropout token a fraction (e.g., 10%) of the times.

### DNN/Deep Generative Approach—Masked Token Modeling

The third approach proposes to model PS parameters with a deep generative approach based on masked token modeling (MTM) (see e.g. H. Chang, H. Zhang, L. Jiang, C. Liu, and W. T. Freeman, “MaskGIT: masked generative image transformer,” in Proc. of the IEEE Int. Conf. on Computer Vision and Pattern Recognition (CVPR), 2022, p. 11315-11325). An example architecture for a masked token generative model (which may be denoted PS-MTM) will be disclosed in the following. The architecture, loss, inputs, and outputs of the model are the same as in the AR approach, including the cross-entropy weights (Eq. 3) and classifier free guidance (Eq. 4). The only difference is the sampling procedure and the corresponding masking approach used during both training and testing, which implies different hyperparameters for the testing stage (e.g., τ=4.5 and γ=0.75, but now the temperature parameter τ has a different meaning as explained below). MTM generates patch representations Q with quantized elements Q_{i,j} which are dubbed as tokens. Q has dimensions B×N, with N being the number of considered audio frames; the maximum number of tokens may for instance be 31×8 as defined in the Encoding section above. During training, the teacher forcing context Q is masked uniformly at random, and only the ground truth elements corresponding to the masked positions are used to compute the cross-entropy loss. The number of elements to mask is also selected at random following a cosine schedule in accordance with H. Chang et. al. referenced above (this specifically includes the case where all patch elements are masked). MTM sampling is an iterative process that achieves orders of magnitude speedups compared to autoregressive modeling (MTM may for instance use 20 steps for a full 6 s patch while AR may require B=34 steps for just a single audio frame of a few milliseconds). MTM iteratively samples a masked patch, performs predictions with classifier free guidance, chooses the predictions with the highest logit score for the next iteration (they will become unmasked and fixed), and reduces the percent of masked tokens following the same scheduling as in training until no masked elements remain (last iteration). During sampling, masking is not random, but based on logit scores (lowest ones are chosen), and a noise term is added to promote diversity. In our case, Gaussian noise with zero mean and a standard deviation t are employed, which becomes the redefined temperature parameter.

In the above examples of the PS-AR model of the second approach and the PS-MTM of the third approach, the model hyperparameters may be tuned by qualitative inspection in a preliminary analysis stage. The neural networks may be implemented using Pytorch's defaults and be trained with Adam for 700 epochs using a batch size of 128 and a learning rate of 10⁻⁴ with warmup-cosine scheduling.

In an extension of the DNN-based approaches, such as the second approach (PS-AR) and the third approach (PS-MTM), the generative model may further be configured to receive conditioning information comprising an audio content type indicator and/or a target stereo image.

The audio content type indicator may involve a description of audio content among a plurality of different descriptions of audio content, for instance different music genres (rock, pop, classical, jazz, electronic, etc.), and/or different audio scenes (concerts, interviews, presentations, outdoor environments, etc.) The audio content description may be obtained in the form of a text descriptor (e.g., “rock”, “pop” or “concert”, “interview”, etc.), some other predetermined form of label, or some features from a pre-trained neural network (e.g., a tagging network, a classification network, etc.). During training, the generative model may be trained using a training corpus of audio signals of the different types of audio content, and the corresponding audio description as conditioning information.

Additionally, or alternatively, the conditioning information may comprise a target stereo image. The target stereo image may be like the audio content description provided in the form of a text descriptor (e.g., “narrow”, wide”) or some other predetermined label or pre-trained network feature. The target stereo image may alternatively be provided in the form of a stereo audio signal (unrelated to the input mono audio signal) having a desired stereo image. During training, the generative model may be trained to, given an input mono audio signal and conditioning information indicating a target stereo image (e.g., text descriptor, label or stereo audio signal), generate PS parameters resulting in a stereo audio signal with a stereo image corresponding to the conditioning information.

The generative model may for example convert the audio content type indicator (e.g., the text string or label) and/or the target stereo image into a learnable embeddings vector. The learnable embeddings vector may be summed with the input features derived from the spectral representation of the mono audio signal, and where applicable any teacher-forcing information (e.g., to form the activation H). For instance, in case the generative model comprises a transformer architecture, the learnable embeddings vector may be summed with the input prior to the transformer encoder block or blocks.

During inference, the parametric stereo parameters may accordingly be generated by inputting, to the generative model, the mono audio signal and the conditioning information comprising an audio content type indicator and/or a target stereo image.

### Testing

Table 1 show results for objective and subjective evaluations for each of the above-discussed approaches for PS generation in addition to original stereo and its mono downmix, and two additional baselines for comparison.

The first baseline corresponds to an ablation of the deep generative approaches and tries to answer the question of whether a generative component is needed or convenient for the task. Thus, the baseline consists of a neural network with the exact same configuration as PS-AR (second approach) or PS-MTM (third approach) but substituting the generative part by standard regression with mean-squared error. This baseline is termed PS-Reg. In preliminary analysis, it was observed that PS-Reg accurately estimated IC values, but consistently failed to predict IIDs. The predicted IIDs had minimal deviation from zero, which can be attributed to the probability distribution function of IID values being centered around zero with equally plausible deviations to the right and to the left. This was an early indication that the one-to-many mapping of IID prediction cannot be correctly handled by regression methods, and that the task would be better served by a generative approach.

The second baseline (termed Decorr) considered corresponds to a variant of classical decorrelation approaches. Here, the decorrelation is implemented by means of an all-pass filter network enhanced by (i) detection and preservation of transients, and (ii) a frequency-dependent mix between original and decorrelated signals to achieve a frequency-dependent IC.

Absent any established no objective measurements for plausible stereo renderings nor suitable PS prediction scores, and due to the highly creative/subjective nature of the task, common error measurements may not be appropriate. Therefore, as a way of measuring progress, a couple of metrics inspired from the literature on generative modeling are introduced.

The first metric considered is the minimum error on a large sample basis, Emin. Given a large sample of generated PS parameters (K=128 for a single audio excerpt), Emin chooses the minimum error with respect to the ground truth:

$${E}_{m i n} = {min}_{k} [ {\sum }_{i , j} δ ( {P}_{i , j} , {\hat{P}}_{i , j}^{( k )} ) ]$$

where δ is a suitable error function. The idea is that if the model is allowed to generate many samples for every input, in the limit of very large K one of them should come close to the ground truth. For PS parameters, absolute errors are used, the IID are weighted to compensate magnitudes with IC, and some perceptual relevance for IID is also taken into account as discussed in connection with the second approach and Eq. 3:

$$δ ( x , y ) = \{ \begin{matrix}λ \vert {[ x ]}_{\pm ϵ} - {[ y ]}_{\pm ϵ} \vert & for IID \\ \vert x - y \vert & for IC\end{matrix}$$

The second metric considered is the Frechet distance on the PS parameter space, D_{F}. Given a pool of PS parameters [symbol] and a K times larger pool of generated parameters [symbol] , assuming Gaussian distributions, D_{F} is computed as

$$\begin{matrix}{D}_{F} = {\vert μ ( 𝒫 ) - μ ( \hat{𝒫} ) \vert}^{2} + \\ + Tr \{ σ ( 𝒫 ) + σ ( \hat{𝒫} ) - 2 √ ( σ ( 𝒫 ) σ ( \hat{𝒫} ) \}\end{matrix}$$

where Tr{ } denotes the matrix trace and μ and σ correspond to the mean vector and the covariance matrix over frames, respectively. The Frechet distance has become a standard measure in generative modeling where, instead of the PS parameters used here, activations of pre-trained classification networks are used.

To train and evaluate all approaches a collection of professionally-recorded stereo music tracks at 44.1 kHz was used. 419,954 tracks were considered for training and 10 k for evaluation, and a 10 s chunk was randomly extracted from each track. During training, 6 s patches were sampled from those, and data augmentation was performed using a random gain and also randomly switching left and right channels. For the PS-NN approach, the number of nearest neighbors considered was k=1.

TABLE 1
Results for the objective (Eₘᵢₙ, D_{F}) and subjective (Preference ±
95% confidence interval) evaluations.

| Approach | Eₘᵢₙ ↑ | D_{F} ↓ | Preference ↑ |
|---|---|---|---|
| Mono | 0.104 | 20.89 | 0.090 ± 0.042 |
| PS-Reg | 0.068 | 8.11 | 0.451 ± 0.066 |
| Decorr | 0.093 | 8.32 | 0.457 ± 0.064 |
| PS-AR | 0.074 | 0.62 | 0.527 ± 0.060 |
| PS-NN | 0.089 | 3.08 | 0.582 ± 0.057 |
| PS-MTM | 0.068 | 0.59 | 0.608 ± 0.050 |
| Stereo | 0.000 | 0.03 | 0.908 ± 0.042 |

Given the creative/subjective nature of the task, the best way to measure performance is through subjective testing. In the subjective testing, a preference test was run with 24 listeners on 7 song excerpts of 10 s from the test set. To select those excerpts, the test excerpts were ranked based on w (Eq. 3) and randomly selected from the top quartile. When doing so, it was manually verified that the selected excerpts covered distinct musical genres and ensured that a PS-decoded version did not exhibit significant coding degradation (this way, the listener was primed to focus on the stereo image instead of potential artifacts introduced by the particular implementation of PS used). The test consisted of providing a rating between 0 and 100 to 7 approaches: the three proposed ones, the two baselines, the mono downmix, and the original stereo signal (professional mix, non-coded). Mono and stereo signals provided intuitive bounds for the analysis of preference, and also served to discard non-expert listeners. Indeed, it was found that the task is quite hard for non-experts, who provided many inconsistent ratings when asked to evaluate an appropriate balance between the width and the clarity of the mix. The most obvious of those inconsistencies were used to discard listeners from the test, namely the fact that they rated mono (input) over stereo (professional mix) in one or more occasions. Half of the users (12) did not incur into such inconsistency and were considered reliable enough to derive conclusions from their ratings. To compensate for differences in subjective scales, excerpt preference tuples were normalized between 0 and 1 (that is, the ratings were normalized for the 7 approaches independently per audio excerpt and listener).

To measure statistical significance, pairwise Wilcoxon signed-rank tests were used, and the Holm-Bonferroni adjustment was applied for multiple testing with p=0.05. The Wilcoxon signed-rank test is appropriate for this case as it is non-parametric and designed for matched samples.

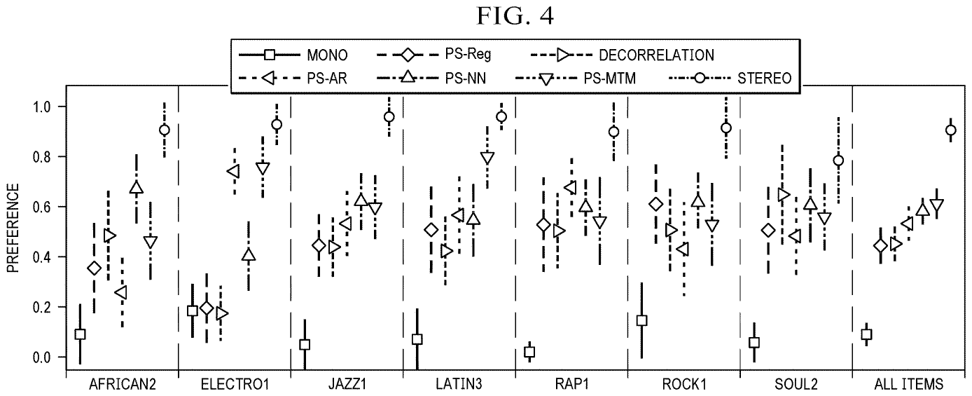

FIG. 4 depict the average listener preference for each item and approach. Despite the different preferences on individual excerpts, upon inspection a clear pattern emerges when considering all items: proposed approaches rank better than mono and the considered baselines (FIG. 1, right). Table 1 confirms that, on average, PS-AR is preferred over the baseline approaches and that, in turn, PS-NN and PS-MTM are preferred over PS-AR. Overall, the results show that a generative approach to PS prediction can become a compelling system for mono-to-stereo.

### Variations

Systems and methods disclosed in the present disclosure may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

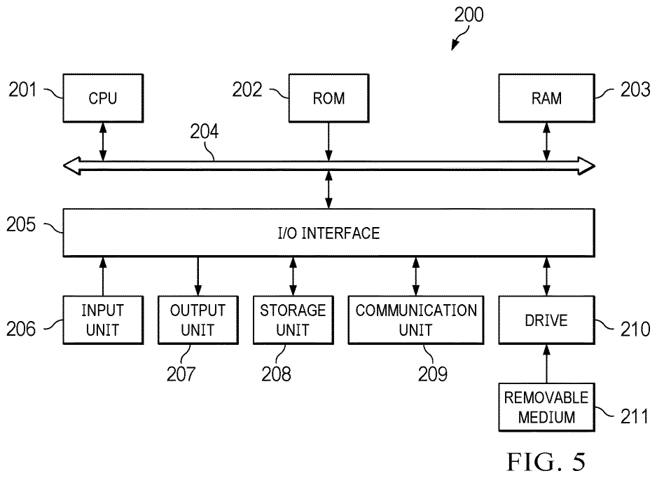

FIG. 5 shows a schematic block diagram of an example electronic device or architecture 200 (e.g., an apparatus 200) suitable for implementing example embodiments of the present disclosure. Architecture 200 includes but is not limited to encoder 1, decoder 2, and the implementation of machine learning model 3 as described in relation to FIGS. 1 and 2. As shown, the architecture 200 includes central processing unit (CPU) 201 which is capable of performing various processes in accordance with a program stored in, for example, read only memory (ROM) 202 or a program loaded from, for example, storage unit 208 to random access memory (RAM) 203. The CPU 201 may be, for example, an electronic processor 201, which may include one or more processor cores, and in some examples the processor 201 may be multiple processors. In RAM 203, the data required when CPU 201 performs the various processes is also stored, as required. CPU 201, ROM 202 and RAM 203 are connected to one another via bus 204. Input/output (I/O) interface 205 is also connected to bus 204.

The following components are connected to I/O interface 205: input unit 206, that may include a keyboard, a mouse, or the like; output unit 207 that may include a display such as a liquid crystal display (LCD) and one or more speakers; storage unit 208 including a hard disk, or another suitable storage device; and communication unit 209 which may include a network interface card such as a network card (e.g., wired or wireless).

In some implementations, input unit 206 includes one or more microphones in different positions (depending on the host device) enabling capture of audio signals in various formats (e.g., mono, stereo, spatial, immersive, and other suitable formats).

In some implementations, output unit 207 include systems with various number of speakers. Output unit 207 (depending on the capabilities of the host device) can render audio signals in various formats (e.g., mono, stereo, immersive, binaural, and other suitable formats).

In some embodiments, communication unit 209 is configured to communicate with other devices (e.g., via a network). Drive 210 is also connected to I/O interface 205, as required. Removable medium 211, such as a magnetic disk, an optical disk, a magneto-optical disk, a flash drive or another suitable removable medium is mounted on drive 210, so that a computer program read therefrom is installed into storage unit 208, as required. A person skilled in the art would understand that although apparatus 200 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 209, and/or installed from the removable medium 211, as shown in FIG. 5.

Generally, various example embodiments of the present disclosure may be implemented in hardware or special purpose circuits (e.g., control circuitry), software, logic or any combination thereof. For example, the various elements of FIGS. 1 and 2 discussed above can be executed by control circuitry (e.g., CPU 201 in combination with other components of FIG. 5), thus, the control circuitry may be performing the actions described in this disclosure.

Some aspects may be implemented in hardware, while other aspects may be implemented in firmware or software which may be executed by a controller, a processor and/or other computing device(s), which may include control circuitry. While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

Computer program code for carrying out methods of the present disclosure may be written in any combination of one or more programming languages. These computer program codes may be provided to one or more processors of a general-purpose computer, special purpose computer, or other programmable data processing apparatus that has control circuitry, such that the program codes, when executed by one or more processors of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as ROM, PROM, EPROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

The implementation of the technologies disclosed in the figures are merely illustrative examples, and the invention is not so limited. For example, the illustrated partitions such as blocks in FIGS. 1 and 2 are merely illustrative logical partitions for ease of discussion, where such partitions may be split into additional partitions, combined into fewer partitions, supplemented with additional partitions, or reduced by eliminating partitions, without departing from the spirit of the present invention. For the illustrated flow chart of FIG. 3, the partitions of the operational steps, which may be also referred to as functions, steps, operations, processes, or acts, may be combined into fewer steps or split into additional steps, where steps may be reordered or eliminated, in whole or in part, without departing from the spirit of this disclosure.

Unless specifically stated otherwise, as apparent from the following discussions, it is appreciated that throughout the disclosure discussions utilizing terms such as “processing”, “computing”, “calculating”, “determining”, “analyzing” or the like, may refer to the function, action, steps and/or processes of a computer hardware or computing system, or similar electronic computing devices, that manipulate and/or transform data represented as physical, such as electronic, quantities into other data similarly represented as physical quantities.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some, but not other, features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the embodiments described above. On the contrary, many modifications and variations are possible within the scope of the appended claims.

Various aspects of the present disclosure may be appreciated from the following enumerated example embodiments (“EEEs”):
EEE 1. A method for converting a mono audio signal into a stereo audio signal, the method comprising:
   generating parametric stereo parameters by inputting the mono audio signal to a machine learning model, wherein the machine learning model is configured to generate parametric stereo parameters given an input mono audio signal; and
   converting the mono audio signal into the stereo audio signal by performing parametric stereo decoding of the mono audio signal using the generated parametric stereo parameters.
EEE 2. The method of EEE 1, wherein the parametric stereo parameters comprise one or more parameters indicating inter-channel properties.
EEE 3. The method of any of the preceding EEEs, wherein the parametric stereo parameters comprise at least one of an inter-channel intensity difference, an inter-channel coherence value, an inter-channel coherence value, an inter-channel level difference, an inter-channel prediction coefficient, an inter-channel phase difference, and/or an inter-channel time difference.
EEE 4. The method of EEE 3, wherein the parametric stereo parameters comprise inter-channel intensity differences, IID, and inter-channel coherence, IC.
EEE 5. The method of EEE 4, wherein the parametric stereo parameters further comprise inter-channel time differences.
EEE 6. The method of any one of the preceding EEEs, wherein generating the parametric stereo parameters comprises:
   obtaining a spectral representation of the mono audio signal; and
   generating parametric stereo parameters for the spectral representation of the mono audio signal.
EEE 7. The method of EEE 6, wherein obtaining the spectral representation of the mono audio signal comprises transforming the mono audio signal into the spectral representation using a short-time Fourier transform.
EEE 8. The method of any one of EEEs 6-7, wherein the spectral representation of the mono audio signal is a spectrogram.
EEE 9. The method of any of EEEs 6-8, wherein generating the parametric stereo parameters comprises, for each frame of the spectral representation of the mono audio signal:
   generating a key vector based on the frame;
   querying, using the generated key vector, a data structure storing key-value vector pairs, to determine k≥1 sets of parametric stereo parameters, wherein the value vector of each key-value pair comprises a set of parametric stereo parameters, and wherein the k sets of parametric parameters are the k sets of parametric stereo parameters of the data structure associated with the k key vectors nearest the generated key vector; and
   determining a set of parametric stereo parameters for the frame based on the k sets of parametric stereo parameters.
EEE 10. The method of EEE 9, wherein k>1 and wherein determining the set of parametric stereo parameters for the frame comprises randomly selecting one of the k sets of parametric stereo parameters.
EEE 11. The method of any one of EEEs 9-10, wherein the sets of parametric stereo parameters determined for the frames forms a sequence of sets of parametric stereo parameters, wherein the method further comprises performing post-processing of the sequence of sets of parametric stereo parameters, the post-processing comprising:
   performing a sign change of at least one parameter of the set of parametric stereo parameters for a frame on a condition that the sign change results in a smaller distance to a corresponding parameter of the set of parametric stereo parameters for a previous frame; and/or
   smoothing of the sequence of sets of parametric stereo parameters.
EEE 12. The method of any one of EEEs 9-11, wherein generating the respective key vector for each frame comprises computing band energies for the frame.
EEE 13. The method of EEE 12, wherein generating the respective key vector for each frame further comprises computing band energies for a number of neighboring frames to the respective frame and averaging the band energies over the respective frame and the neighboring frames.
EEE 14. The method of any one of EEEs 9-13, wherein the key vector of each key-value pair of the data structure comprises an average band energy.
EEE 15. The method of any one of EEEs 9-14, further comprising:
   obtaining an audio content type indicator; and
   selecting the data structure from a set of data structures, wherein each data structure is associated with a respective audio content type indicator, and wherein the data structure is selected in accordance with the obtained audio content type indicator.
EEE 16. The method of any of EEEs 6-8, wherein the machine learning model is configured as a deep neural network comprising a generative model trained to generate, based on the spectral representation, the parametric stereo parameters.
EEE 17. The method of EEE 16, wherein generating the parametric stereo parameters comprises generating, for each frame of the spectral representation of the mono audio signal, a set of parametric stereo parameters using the deep neural network.
EEE 18. The method of any one of EEEs 16-17, wherein the generative model comprises at least one of a generative adversarial network, a diffusion model, an autoregressive model, and/or a masked token generative model.
EEE 19. The method of EEE 18, wherein the generative model comprises an autoregressive model or a masked token generative model.
EEE 20. The method of EEE 19, wherein the generative model comprises a transformer architecture.
EEE 21. The method of EEE 19-20, wherein the generative model is trained to minimize a categorical cross-entropy loss.
EEE 22. The method of anyone of EEEs 19-21, wherein the PS parameters are generated using classifier-free guidance.
EEE 23. The method of any one of EEEs 16-22, wherein the generative model comprises a masked token generative model trained to generate patch representations comprising parametric stereo parameters for a number of frames, wherein the parametric stereo parameters define tokens of the patch representations, and a patch representation is generated by iteratively:
   sampling a masked patch,
   predicting tokens of the masked patch,
   selecting a number of the predicted tokens with a highest logit score, and
   unmasking the selected number of predictions for the next iteration.
EEE 24. The method of EEE 23, wherein the tokens are predicted using classifier-free guidance.
EEE 25. The method of any one of EEEs 16-24, wherein the generative model is further configured to receive conditioning information comprising an audio content type indicator and/or a target stereo image, and to generate the parametric stereo parameters given the input mono audio signal and the conditioning information, and wherein generating the parametric stereo parameters comprises inputting, to the generative model, the mono audio signal and conditioning information comprising an audio content type indicator and/or a target stereo image.
EEE 26. A system for converting a mono audio signal into a stereo audio signal, the system comprising:
   a machine learning model configured to generate parametric stereo parameters given an input mono audio signal; and
   a parametric stereo decoder configured to convert the input mono audio signal into the stereo audio signal using the parametric stereo parameters generated by the machine learning model.
EEE 27. A computer program product comprising computer program code portions configured to perform the method according to any one of EEEs 1-25 when executed on a computer processor.
EEE 28. A computer-readable storage medium storing the computer program product according to EEE 27.
EEE 29. A method for converting a mono audio signal into a stereo audio signal, the method comprising:
   generating one or more parameters indicating inter-channel properties from a machine learning model; and
   reconstructing the stereo audio signal from the one or more generated parameters indicating inter-channel properties and the mono audio signal.
EEE 30. The method of EEE 29, wherein the one or more parameters indicating inter-channel properties comprise parametric stereo parameters.
EEE 31. The method of EEE 29 or 30, wherein the machine learning model is configured based on nearest neighbor decoding.
EEE 32. The method of EEE 29 or 30, wherein the machine learning model is configured based on a deep neural network.
EEE 33. The method of any of EEEs 29-32, wherein generating the one or more parameters indicating inter-channel properties from the machine learning model, comprises:
   inputting, to the machine learning model, the mono audio signal, wherein the machine learning model is configured to generate the one or more parameters indicating inter-channel properties based on the mono audio signal input.
EEE 34. The method of any of EEEs 29-33, wherein the one or more parameters indicating inter-channel properties comprise at least one of an inter-aural intensity difference, an inter-aural coherence value, an inter-channel coherence value, an inter-channel level difference, an inter-channel prediction coefficient, an inter-channel phase difference, and/or an inter-channel time difference.
EEE 35. The method of any of EEEs 29-34, when dependent on EEE 3, wherein generating the one or more parameters indicating inter-channel properties from a machine learning model comprises:
   obtaining spectral representations of the mono audio signal;
   averaging groups of the spectral representations;
   querying a database for each averaged group to determine a set of one or more parameters indicating inter-channel properties corresponding to k nearest neighbors of each averaged group, wherein k>=1; and
   determining, for each averaged group, one or more parameters indicating inter-channel properties from the set to correspond to the generated one or more parameters indicating inter-channel properties.
EEE 36. The method of any of EEEs 29-34, when dependent on EEE 4, wherein generating the one or more parameters indicating inter-channel properties from a machine learning model comprises:
   obtaining spectral representations of the mono audio signal;
   generating, using a deep neural network, one or more parameters indicating inter-channel properties, wherein the deep neural network is trained to:
      generate, based on the spectral representation, one or more parameters indicating inter-channel properties.
EEE 37. The method of EEE 35 or 36, wherein obtaining the spectral representation of the mono audio signal comprises transforming the mono audio signal into the spectral representation using a short-time Fourier transform.
EEE 38. The method of EEE 36, wherein the deep neural network comprises a generative model.
EEE 39. The method of EEE 38, wherein the generative model comprises at least one of a generative adversarial network, a diffusion model, an autoregressive model, and/or a masked token generative model.
EEE 40. The method of any of EEEs 29-39, wherein reconstructing the stereo audio signal from the one or more generated parameters indicating inter-channel properties and the mono audio signal comprises reconstructing the stereo audio signal using parametric stereo decoding.
EEE 41. A computer program product comprising computer program code portions configured to perform the method according to one of EEEs 29-40 when executed on a computer processor.

1. A method for converting a mono audio signal into a stereo audio signal, the method comprising:
generating parametric stereo parameters by inputting the mono audio signal to a machine learning model, wherein the machine learning model is configured to generate parametric stereo parameters given an input mono audio signal; and
converting the mono audio signal into the stereo audio signal by performing parametric stereo decoding of the mono audio signal using the generated parametric stereo parameters.

2. The method of claim 1, wherein the parametric stereo parameters comprise one or more parameters indicating inter-channel properties.

3. The method of claim 1, wherein the parametric stereo parameters comprise at least one of an inter-channel intensity difference, an inter-channel coherence value, an inter-channel coherence value, an inter-channel level difference, an inter-channel prediction coefficient, an inter-channel phase difference, and/or an inter-channel time difference.

4. The method of claim 3, wherein the parametric stereo parameters comprise at least one of inter-channel intensity differences, IID, inter-channel coherence, IC, and inter-channel time differences.

5. (canceled)

6. The method of claim 1, wherein generating the parametric stereo parameters comprises:
obtaining a spectral representation of the mono audio signal; and
generating parametric stereo parameters for the spectral representation of the mono audio signal.

7. (canceled)

8. (canceled)

9. The method of claim 6, wherein generating the parametric stereo parameters comprises, for each frame of the spectral representation of the mono audio signal:
generating a key vector based on the frame;
querying, using the generated key vector, a data structure storing key-value vector pairs, to determine k≥1 sets of parametric stereo parameters, wherein the value vector of each key-value pair comprises a set of parametric stereo parameters, and wherein the k sets of parametric parameters are the k sets of parametric stereo parameters of the data structure associated with the k key vectors nearest the generated key vector; and
determining a set of parametric stereo parameters for the frame based on the k sets of parametric stereo parameters.

10. (canceled)

11. The method of claim 9, wherein the sets of parametric stereo parameters determined for the frames forms a sequence of sets of parametric stereo parameters, wherein the method further comprises performing post-processing of the sequence of sets of parametric stereo parameters, the post-processing comprising:
performing a sign change of at least one parameter of the set of parametric stereo parameters for a frame on a condition that the sign change results in a smaller distance to a corresponding parameter of the set of parametric stereo parameters for a previous frame; and/or
smoothing of the sequence of sets of parametric stereo parameters.

12. The method of claim 9, wherein generating the respective key vector for each frame comprises computing band energies for the frame.

13. The method of claim 12, wherein generating the respective key vector for each frame further comprises computing band energies for a number of neighboring frames to the respective frame and averaging the band energies over the respective frame and the neighboring frames.

14. The method of claim 9, wherein the key vector of each key-value pair of the data structure comprises an average band energy.

15. The method of claim 9, further comprising:
obtaining an audio content type indicator; and
selecting the data structure from a set of data structures, wherein each data structure is associated with a respective audio content type indicator, and wherein the data structure is selected in accordance with the obtained audio content type indicator.

16. The method of claim 6, wherein the machine learning model is configured as a deep neural network comprising a generative model trained to generate, based on the spectral representation, the parametric stereo parameters.

17. The method of claim 16, wherein generating the parametric stereo parameters comprises generating, for each frame of the spectral representation of the mono audio signal, a set of parametric stereo parameters using the deep neural network.

18. The method of claim 16, wherein the generative model comprises at least one of a generative adversarial network, a diffusion model, an autoregressive model, and/or a masked token generative model.

19. (canceled)

20. (canceled)

21. (canceled)

22. The method of claim 16, wherein the PS parameters are generated using classifier-free guidance.

23. The method of claim 16, wherein the generative model comprises a masked token generative model trained to generate patch representations comprising parametric stereo parameters for a number of frames, wherein the parametric stereo parameters define tokens of the patch representations, and a patch representation is generated by iteratively:
sampling a masked patch,
predicting tokens of the masked patch,
selecting a number of the predicted tokens with a highest logit score, and
unmasking the selected number of predictions for the next iteration.

24. (canceled)

25. The method of claim 16, wherein the generative model is further configured to receive conditioning information comprising an audio content type indicator and/or a target stereo image, and to generate the parametric stereo parameters given the input mono audio signal and the conditioning information, and wherein generating the parametric stereo parameters comprises inputting, to the generative model, the mono audio signal and conditioning information comprising an audio content type indicator and/or a target stereo image.

26. A system for converting a mono audio signal into a stereo audio signal, the system comprising:
a machine learning model configured to generate parametric stereo parameters given an input mono audio signal; and
a parametric stereo decoder configured to convert the input mono audio signal into the stereo audio signal using the parametric stereo parameters generated by the machine learning model.

27. A computer program product comprising computer program code portions configured to perform the method according to claim 1 when executed on a computer processor.

28. A non-transitory computer-readable storage medium storing the computer program product according to claim 27.
